(19) United States
(12) Patent Application Publication
(10) Pub. No.: US 2019/0118305 A1
(43) Pub. Date: Apr. 25, 2019

(54) LASER 3D PROCESSING SYSTEM

(71) Applicant: Seakjoon LEE, Uiwan-si Gyeonggi-do (KR)

(72) Inventor: Seakjoon LEE, Uiwan-si Gyeonggi-do (KR)

(21) Appl. No.: 16/311,705

(22) PCT Filed: May 7, 2017
(86) PCT No.: PCT/KR2017/004732

§ 371 Date: Dec. 20, 2018

(30) Foreign Application Priority Data
Jul. 1, 2016 (KR) 10-2016-0083235

(51) Int. Cl. B23K 26/402; G02B 26/10; G02B 26/08; B23K 26/00; B23K 26/082; B23K 26/08; B23K 26/06

(52) U.S. Cl. CPC B23K 26/402; G02B 26/10; G02B 26/0816; B23K 26/0006; A61C 13/0004; B23K 26/0823; B23K 26/0643; B23K 26/0665; B23K 26/0648; B23K 26/0821

(57) ABSTRACT

The present invention relates to a laser three-dimensional processing system, and more particularly, to a laser three-dimensional processing system capable of forming a pattern or cutting, marking, welding, milling or welding while scanning an object for dental prosthesis.

The laser three-dimensional processing system of the present invention employs a laser scanning method in which laser beam is formed on an object by using a reflection mirror without a laser head, thereby improving the processing speed from several tens to hundreds of times. That is, instead of transferring a heavy laser head, transferring a few tens of grams of a light reflective mirror can reduce the inertia of several tens to hundreds of times, resulting in a high speed, high precision curve and three dimensional processing can be performed.

### TECHNICAL FIELD

This invention relates to a laser three-dimensional processing system, and more particularly, to a laser three-dimensional processing system capable of cutting, marking, patterning, welding, milling or welding for three-dimensional shapes and specially for three-dimensional shapes scanned three-dimensionally.

### BACKGROUND TECHNOLOGY

In recent years, the use of lasers has been increasing in cutting, welding and forming patterns on materials.

Since the method using the laser has a remarkable advantage over the processing speed and precision compared with the conventional processing method, its use has been applied to various fields in recent years.

Particularly, there is disclosed a technique of processing by using a laser in the artificial tooth processing

The Korean Registered Utility Model No. 20-295086 of the prior art discloses a dental table unit for tooth processing in which a surgical microscope, a tooth fixing fixture, a physiological saline solution, a plasma irradiation lamp, an illumination lamp and a dental engine unit are integrally mounted. This technique has the problem that the precision of the processing is lowered because the person directly processes the teeth.

In order to solve such a problem, Korean Patent Laid-Open Publication No. 10-2009-0114913 discloses an artificial tooth fixing unit for fixing and rotating an artificial tooth, a first end portion for processing the artificial tooth in six axes, and a second end portion, A three-dimensional artificial tooth processing apparatus capable of processing a tooth has been disclosed, which is a generally known art because it is manufactured by cutting an artificial tooth with a large number of end mills, and it is difficult to precisely process a tooth.

In order to solve such a problem, Korean Patent Laid-Open Publication No. 10-2005-0035802 discloses a laser processing machine for dental prosthesis having a laser processing head for processing an artificial tooth by using a laser. This method has many problems because there is a problem in that a long time is required because the corresponding head is moved and processed directly for each desired region and the machining operation is not performed while the head is being driven, and the object is fixed to the annular rod having one rotation axis There is a problem that side processing is not easy.

### DETAILED DESCRIPTION OF THE INVENTION

### Technical Challenge

Accordingly, the present invention has been made to solve the above-mentioned problems occurring in the prior art, and it is an object of the present invention to provide a laser three-dimensional processing system employing a laser scanning method for forming a line beam on an object,

The present invention also provides a laser three-dimensional processing system having a rotating clamp so that an object has two or more axes of rotation.

The present invention also includes a lens unit and a fine auto-focus adjusting unit for automatically adjusting a beam size and a focus of a laser irradiated according to a machining point of an object and synchronizing the lens unit, the reflecting mirror unit, Dimensional laser processing system.

### Technical Solution

In order to achieve the above object, the present invention provides a laser three-dimensional processing system. This includes an optical system including a laser oscillator for generating a laser, a lens unit for adjusting the beam size of the laser emitted from the laser oscillator and forming a laser focus on the processing line of the object, a reflection mirror unit, and a laser spot beam, And a driving motor for driving the reflection mirror portion so as to be formed of a beam, wherein a laser beam passing through the optical system is reflected by the reflection mirror portion and irradiated to an object to be rotated, a rotation clamp for rotating the object while the object is fixed, And a control unit for controlling the driving motor and the rotating clamp so that the laser beam reflected from the system is irradiated to the object to be rotated to form a line beam. The rotating clamp has a body formed with a guide part, one end coupled with the guide part, And a rotating supporting member and a supporting member, And a rotating clamp drive motor for controlling the rotating clamp drive motor to move along the deck section.

The body has a curvature such that when the supporter moves along the guide, the object is held within the range irradiated with the laser, and the guide is formed on the inner surface of the body.

The reflection mirror part is characterized by being a reflection mirror, a galvanometer, a polygon mirror, or a combination of a galvanometer and a polygon mirror.

The focal length of the lens unit, the beam size of the optical system, the driving speed of the reflecting mirror unit, the rotation speed of the supporter unit for rotating the object, and the movement speed of the supporter unit moving along the guide unit are synchronized with each other.

The reflection mirror section includes a plurality of reflection mirrors, and the rotation and movement control of the supporter is made non-synchronous, and the angle of each of the reflection mirrors is adjusted to perform surface processing on one surface of the object.

And the reflection mirror portion is driven to have an angle of reflection of 60 degrees or less.

The lens unit is characterized by being composed of a single lens or a combination of lenses for adjusting the focus of the laser beam irradiated to the object and adjusting the beam size.

And a fine automatic focus adjusting unit is provided between the reflecting system and the object.

And the fine auto-focus adjusting unit includes any one of an f-theta lens and a telecentric lens.

### Effects of the Invention

The laser three-dimensional processing system of the present invention employs a laser scanning method in which a line mirror is formed on an object by using a reflection mirror without a laser head, thereby improving the processing speed from several tens to hundreds of times. That is, instead of transferring a heavy head, transferring a few tens of grams of a light reflective mirror can reduce the inertia of several tens to hundreds of times, resulting in a high speed, high precision curve and three-dimensional processing can be performed.

Further, since the present invention is provided with a rotating clamp so that the object has two or more rotary shafts, side processing of the object is precise and easy.

The present invention also includes a lens unit and a fine auto-focus adjusting unit for automatically adjusting a beam size and a focus of a laser irradiated according to a machining point of an object and synchronizing the lens unit, the reflecting mirror unit, Therefore, there is an effect that precision processing can be performed. For example, when dental ceramics is machined, the beam size is increased to perform roughing, and in precision machining, the beam size can be reduced to reduce the overall machining time

### BRIEF DESCRIPTION OF DRAWINGS

FIG. 1 is a view showing a straight line beam formed on an object according to an embodiment of the present invention.

FIG. 2 is a view showing a curved line beam formed on an object according to another embodiment of the present invention.

FIG. 3 is an enlarged view of a portion where the curved line beam of FIG. 2 is formed.

### DETAILED DESCRIPTION OF THE INVENTION

The terms and words used in the present specification and claims should not be construed as limited to ordinary or dictionary terms and the inventor may properly define the concept of the term to describe its invention in the best possible way, and it should be construed as meaning and concept consistent with the technical idea of the present invention.

Therefore, the embodiments described in this specification and the configurations shown in the drawings are only the most preferred embodiments of the present invention and do not represent all the technical ideas of the present invention. Therefore, It should be understood that equivalents and modifications are possible.

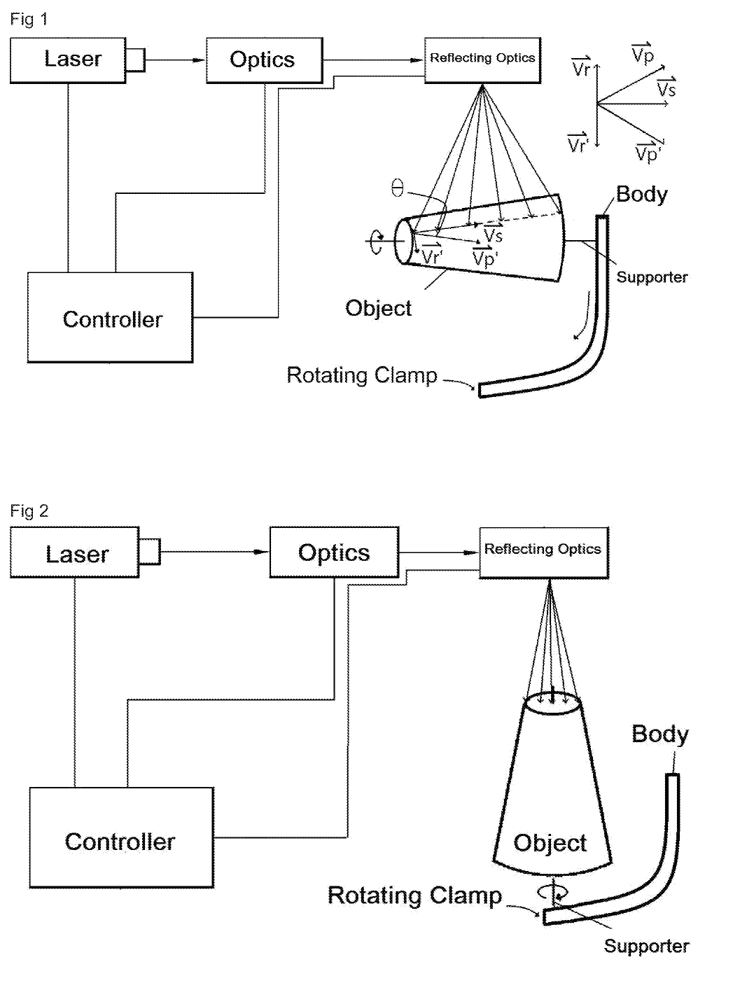

FIG. 1 is a view showing a straight line beam formed on an object according to an embodiment of the present invention

Referring to FIG. 1, the laser three-dimensional processing system of the present invention comprises a laser oscillator, an optical system, a reflectometer, a rotating clamp, and a control unit.

The laser oscillator has generally laser beam power distribution of Gaussian form. The middle of the beam has high power and the outsides of the beam have low power.

The optical system includes a lens portion that adjusts the beam size of the laser emitted from the laser oscillator and causes the laser focus to be formed on the working line of the object. The lens unit is composed of a single lens or a combination of lenses for adjusting the focus of the laser irradiated on the object and adjusting the beam size.

When the above-described lens unit is formed of a combination of a convex lens and a concave lens, a concave lens may be provided on the right side of the convex lens, or a convex lens may be provided on the rear side of the concave lens

The convex lens and the concave lens move or move together to move toward or away from each other, and the size of the laser beam passing through each lens becomes wider or narrower.

In addition, the lens unit including the convex lens and the concave lens adjusts the distance between the convex lens and the concave lens, as well as the size of the laser beam, so that the position where the focus of the laser beam is formed can be adjusted to some extent in the traveling direction of the laser.

The reflection system includes a reflection mirror unit and a drive motor that drives the reflection mirror unit so that the laser spot beam irradiated to the object is formed into a line beam. The laser beam passing through the optical system described above is reflected through the reflection mirror unit.

The reflection mirror portion may be composed of any one of a reflection mirror, a galvanometer, a polygon mirror, or a combination of a galvanometer and a polygon mirror.

The reflection mirror portion is driven to have an angle of reflection of 60 degrees or less.

For example, when the laser beam incident from the optical system is irradiated to the object, the incident angle and the reflection angle have a driving angle of 60 degrees or less, thereby preventing the size of the laser beam irradiated on the object from being enlarged.

Since the maximum scan distance is determined according to the above-described reflection angle, the size of the object is determined. At this time, it is preferable that the object is equal to or smaller than the maximum scan distance.

Here, scanning means that the laser beam scans the surface of the object, and patterning can be performed at a point scanned according to parameters such as the output and irradiation amount of the laser beam, patterning or welding or cutting can be performed.

On the other hand, a Automatic-Precise focusing unit may be provided between the reflection system and the object. On the other hand, a Automatic-Precise focusing unit may be provided between the reflection system and the object. The fine auto-focus adjusting unit can be used to finely adjust the focus of the laser beam irradiated on the object by using any one of the f-theta lens or the telecentric lens which is a flat field lens.

The rotating clamp can rotate the object while the object is fixed.

The rotating clamp includes a body having a guide portion, a rotating clamp driving motor (not shown) which is coupled to the guide portion at one end, supporters a part of the object at the other end and rotates to move the supporter along the guide portion.

On the other hand, when the supporterer moves along the guider, the body has a curvature so that the object is held within a range irradiated with the laser, and the guider can be formed on the inner peripheral surface of the body.

Therefore, working on the side of the object can be facilitated. A signal for moving the supporterer on the guider can be received from the control part.

The control unit controls the driving motor and the rotating clamp so that the laser reflected from the reflection system is irradiated to the object to be rotated to form a line.

At this time, in order to precisely process an object by synchronizing the focal length of the lens unit, the beam size of the optical system, the driving speed of the reflecting mirror unit, and the rotational speed for rotating the object of the rotating clamp, a control signal is transmitted to the optical system. The control unit can calculate the position coordinates of the irradiation line that is actually processed by the driving speed of the reflecting mirror unit and the rotation speed for rotating the object of the rotating clamp, and the control unit can input data on the shape of the object and the position coordinates of the points to be scanned in advance can receive. In addition, data on the size to be scanned of the point to be scanned may also be input.

In addition, the laser three-dimensional processing system of the present invention is limited to a technology application field as a laser three-dimensional processing system for rotating objects, but can be applied to a process of processing an object using a laser.

### Example 1

Referring to FIG. 1, an object is fixed on a supporterer and is rotating.

The rotating direction is the same direction of vector Vr, the vector Vr is the angular velocity of the supporterer rotation, the vector Vr′ is the angular velocity of the laser beam actually irradiated by the object rotation, and the vector Vs is the velocity of the laser beam irradiated from the reflection system, the vector Vp is a vector generated by the operation of the vector Vr and the vector Vs, and the vector Vp′ is the speed at which the straight line beam of the laser beam is actually irradiated by the rotation of the object. Therefore, the equation for calculating the vector Vp′ can be represented as follows by a simple vector operation.

Vector Vp′=vector Vr′+vector Vs (Equation 1)

The angle between the vector Vs and the vector Vp′ can be calculated through the vector Vr′ and the radius of the bottom surface of the object.

In fact, after the line beam is irradiated to the right at the speed of the vector Vp′, when the laser beam reaches the right end of the object, the line beam is again irradiated to the left side. The object is machined by repeating the above-described operation several times. At this time, assuming that the object is conical as shown in the drawing, the side of the object is processed. On the other hand, in order to process the bottom surface of the conical shape, the supporterer may be moved through the guide portion of the rotating clamp.

### Example 2

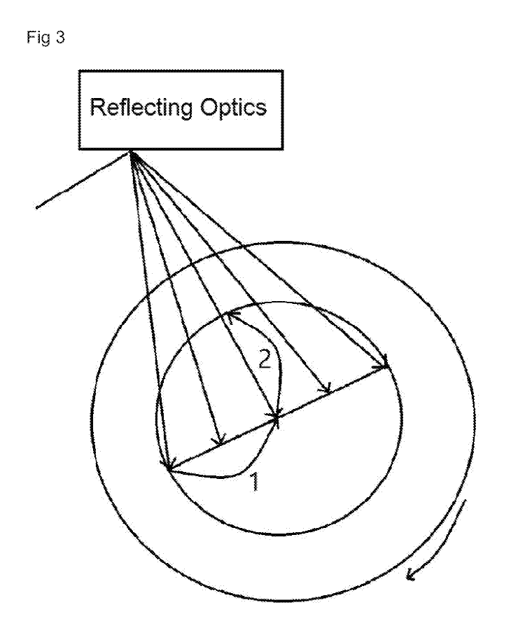

FIG. 2 is a view showing a curved line beam formed on an object according to another embodiment of the present invention, and FIG. 3 is an enlarged view of a portion where the curved line beam is formed. Referring to FIG. 3, which is an enlarged view of a part to be processed of the object shown in FIG. 2, it shows a small conical bottom surface when the object is assumed to be conical.

Here, the bottom surface of the object is arranged in the direction in which the laser is irradiated

At this time, since the supporter is rotating clockwise, the laser beam actually irradiated is formed into a curve. For example, various curved line beams can be formed and processed by controlling the driving speed of the reflecting mirror part and the rotating speed for rotating the object of the rotating clamp through the control part.

Meanwhile, in the case where the object is machined by setting the rotation and movement control of the supporterer to the non-synchronized state by releasing the synchronization, the reflection mirror part may be composed of a plurality of reflection mirrors, Can be processed.

That is, after machining once, the object can be machined by rotating the supporter by rotating the supporter by non-motion, or by moving a supporter moving along the guide to change the surface to be machined.

That is, after machining once, the object can be machined by rotating the supporter by non-motion, or moving by a moving guide to change the surface to be machined.

While the present invention has been particularly shown and described with reference to exemplary embodiments thereof, it is clearly understood that the same is by way of illustration and example only and is not to be taken by way of illustration, Various changes and modifications will be possible.

1. A laser three-dimensional processing system for machining a rotating object,
A laser oscillator for generating a laser beam;
An optical system including a lens unit that adjusts a beam size of the laser beam emitted from the laser oscillator and makes a laser beam to be focused on a working line of the object;
And the reflecting optics including a driving motor for driving the reflection mirror unit such that a laser spot beam irradiating the object to be formed as a line beam, wherein the laser beam passing through the optical system is reflected through the reflection mirror unit;
A rotating clamp for rotating the object while the object is fixed;
And a control unit for controlling the drive motor and the rotating clamp so that the laser beam reflected from the reflecting optics is irradiated to the object to be rotated to form a line beam,
the rotating clamp includes a body having a guide unit, a supporterer having one end coupled to the guide unit and the other end fixed to the object, and a rotating clamp drive motor controlling the supporterer to move along the guide unit, wherein the body has a curvature such that the object is held within a range irradiated by the laser beam when the supporterer moves along the guide unit, and the guide unit is formed on an inner circumferential surface of the body.

2. The method according to claim 1, wherein the reflection mirror unit consists of any one of a reflection mirror, a galvanometer, a polygon mirror, or a combination of a galvanometer and a polygon mirror.

3. The method according to claim 1, wherein a focal length of the lens unit, a beam size of the optical system, a driving speed of the reflective mirror unit, a rotation speed of the supporter unit for rotating the object, and a movement speed of the supporterer moving along the guide unit are synchronized with each other 3D processing system.

4. The method of claim 3, wherein the reflection mirror unit includes a plurality of reflection mirrors and controls the rotation and movement of the supporterer to be non-synchronized, and the angle of each of the reflection mirrors is adjusted so as to process one surface of the object.

5. The method according to claim 1, wherein the reflection mirror portion is driven to have an angle of reflection of 60 degrees or less.

6. The method according to claim 1, wherein the lens unit comprises a single lens or a combination of a plurality of lenses for adjusting focus of the laser beam and adjusting the beam size of the laser beam irradiated on the object.

7. The method according to claim 1, and a fine-automatic focusing unit is provided between the reflection system and the object.

8. The method according to claim 7,
wherein the micro-autofocusing unit comprises any one of an f-theta lens and a telecentric lens.
